(19) United States
(12) Patent Application Publication
(10) Pub. No.: US 2012/0079724 A1
(43) Pub. Date: Apr. 5, 2012

(54) ADJUSTABLE FINGER LOOP STRUCTURE FOR A SCISSORS

(75) Inventor: Chien-Che Huang, Fuxing Township (TW)

(73) Assignee: TAI-WEI SCISSORS CO., LTD., LU-GANG TOWN (TW)

(21) Appl. No.: 12/896,834

(22) Filed: Oct. 1, 2010

(51) Int. Cl. B26B 13/20

(52) U.S. Cl. 30/232

(57) ABSTRACT

An adjustable finger loop structure for a scissors has a scissors body and at least two finger loops. The scissors body has two scissor blades pivoted together, and each scissor blade has an extension rod. The finger loops each has a through aperture along an inner liner side for jacketing onto a respective extension rod, each through aperture having a radial slot, and each radial slot has a plurality of securing apertures passing through the radial slot the and corresponding securing members for securing the finger loop onto the respective extension rod.

### BACKGROUND OF THE INVENTION

1. Field of the Invention

The present invention relates to an adjustable finger loop structure for a scissors, and more particularly to an adjustable finger loop structure for scissors that can provide different adjustable positions and angles.

2. Description of the Related Art

Currently, a prior art of adjustable finger loop structure for a scissors, as shown in FIG. 12 and FIG. 13, comprises a scissor body 30 and a second finger loop 40; the scissor body 30 is composed of two blades, and one of the blades has an extended first finger loop 31 and another blade has an extended connecting rod 32 having a securing aperture 321 and a corresponding securing member 322. The second finger loop 40 comprises a hollow connecting tube 41, a slot 411 with a predetermined length and a loop portion 42 extending from the end of the connecting tube 41. To assemble the scissors body 30, the connecting tube 41 of the second finger loop 40 is jacketed onto the connecting rod 32, and the securing member 322 is placed through the slot 411 to lock onto the connecting rod 32 and push against the inner wall of the connecting tube 41. Therefore, the second finger loop 40 is tightly secured onto the connecting rod 32 of the scissors body 30. However, the prior art structure has the following drawbacks: 1. In order to make the connecting tube 41 of the second finger loop 40 jacket onto the connecting rod 32 of the scissors body 30, the slot 411 needs to be aligned with the securing aperture 321 of the connecting rod 32 such that the second finger loop 40 can only be adjusted up or down rod 32, but cannot be adjusted left or right to provide for different angles. 2. In order to lock the second finger loop 40 onto the connecting rod 32, an outer edge of the securing member 322 needs to push against the first finger loop 31 of the scissors body 30 to provide a stopper between the second finger loop 40 and the first finger loop 31; however, the direct impact between the securing member 322 and the first finger loop 31 causes the securing member 322 to gradually loosen and to be unable to tighten anymore, in which the second finger loop 40 then slips off of the connecting rod 32.

Therefore, it is desirable to provide an adjustable finger loop structure for a scissors to mitigate and/or obviate the aforementioned problems.

### SUMMARY OF THE INVENTION

An objective of the present invention is to provide an adjustable finger loop structure for scissors

In order to achieve the above-mentioned objectives, an adjustable finger loop structure for a scissors comprises a scissor body and two finger loops. The scissors body has two scissor blades pivoted together, and each scissor blade has an extension rod. A surface of the extension rod is roughened, such as by sand-blasting. The two finger loops respectively have one circular hole and a through aperture that runs along an inner liner side and is used for jacketing onto a respective extension rod. Each through aperture has a radial slot, and each radial slot has a plurality of securing apertures passing through the radial slot and corresponding securing members for securing the finger loop onto the respective extension rod.

With the above mentioned structure, the following benefits can be obtained: 1. The finger loop provides not only different adjustable positions and angles on the extension rod but also provides different type combinations. 2. The stopping member is respectively installed behind the finger loop on the extension rod, which is used for preventing contact between the two finger loops.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of an embodiment of the present invention.

FIG. 2 is an exploded view of an embodiment of the present invention.

FIG. 3 is a schematic drawing of different adjusting positions according to an embodiment of the present invention.

FIG. 4 is a schematic drawing of different adjusting angles according to an embodiment of the present invention.

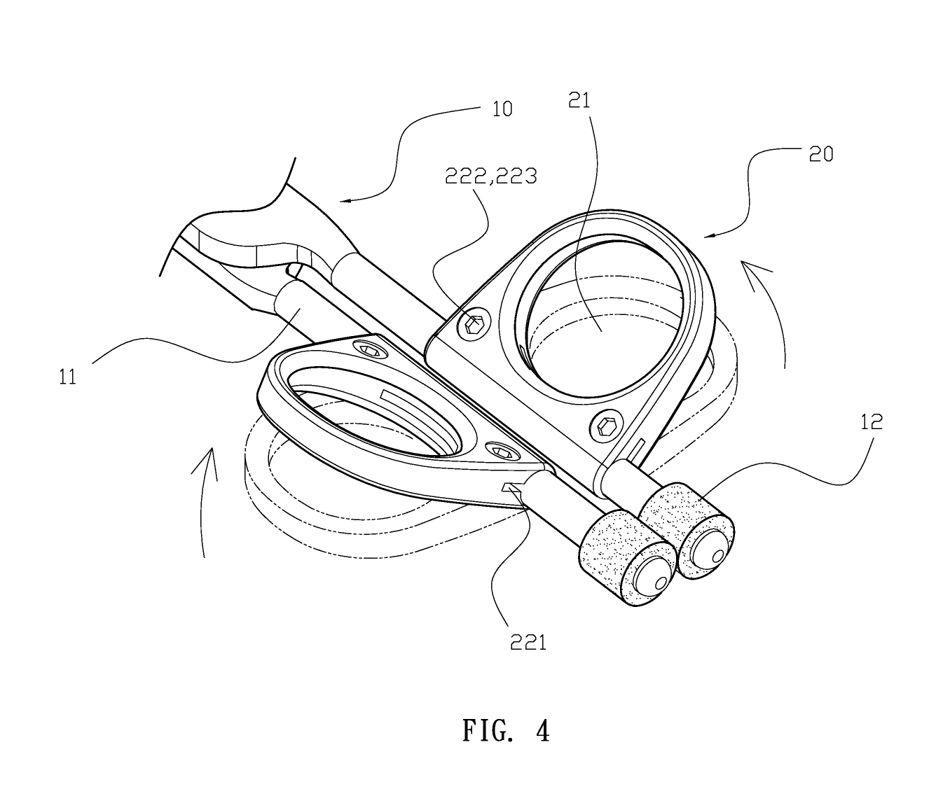

FIG. 5 is a cross-sectional drawing of a finger loop being secured onto an extension rod according to an embodiment of the present invention.

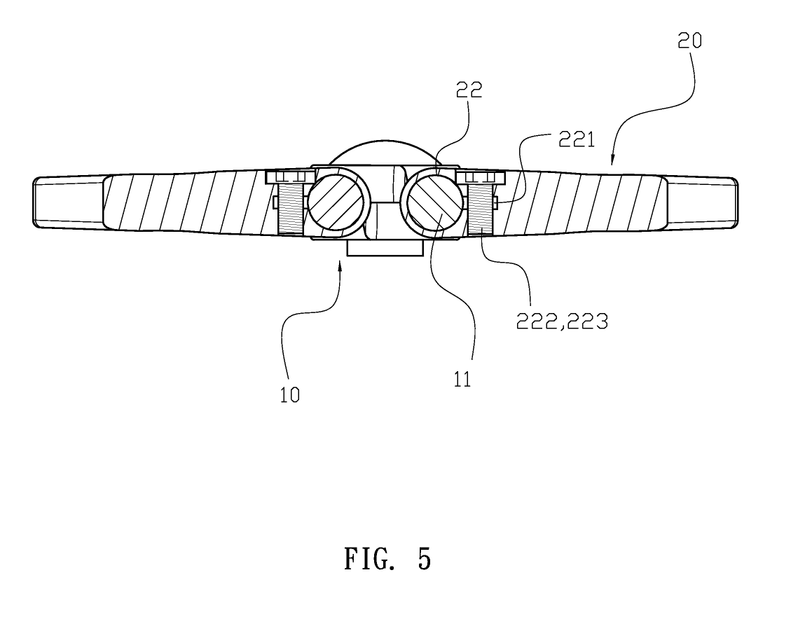

FIG. 6 is a schematic drawing showing a plurality of finger loops installed onto an extension rod according to an embodiment of the present invention.

FIG. 7 is a schematic drawing showing another embodiment of a finger loop according to the present invention.

FIG. 8 is a schematic drawing showing another embodiment of a finger loop with an assisting rod according to the present invention.

FIG. 9 is a schematic drawing showing another embodiment of a finger loop having a supporting portion according to the present invention.

FIG. 10 is a schematic drawing showing a finger loop having a supporting portion and an assisting rod installed on a finger loop extension rod according to an embodiment of the present invention.

FIG. 11 is a schematic drawing showing a finger loop having an indented surface.

FIG. 12 is a perspective view of a prior art scissors.

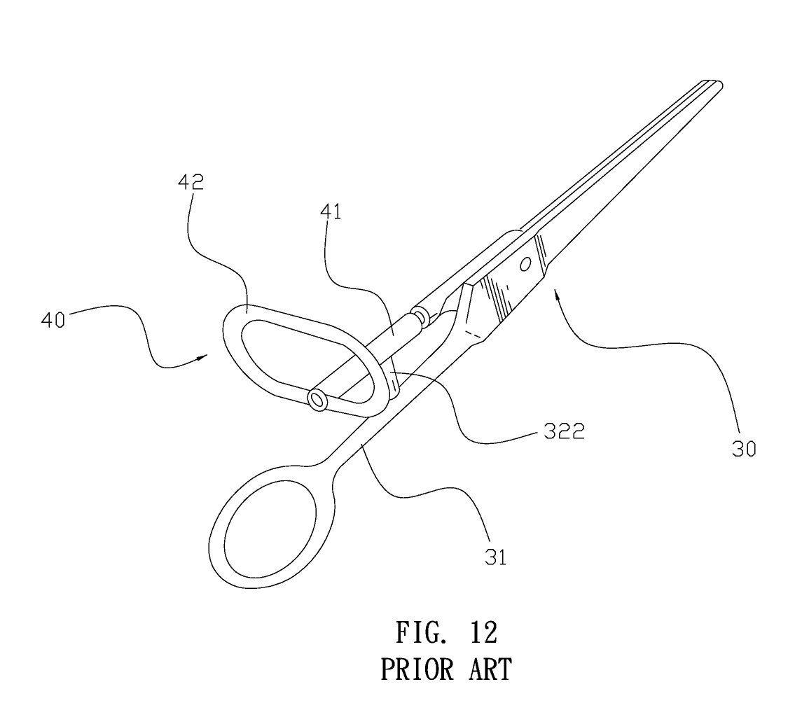

FIG. 13 is a cross-sectional drawing of the prior art scissors shown in FIG. 12.

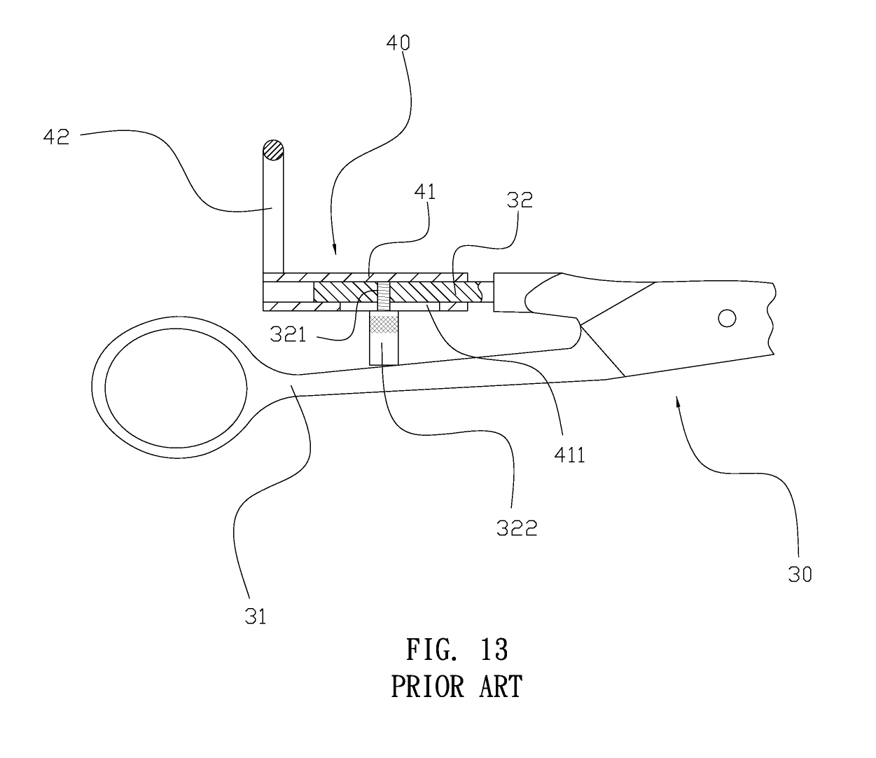

### DETAILED DESCRIPTION OF THE PREFERRED EMBODIMENT

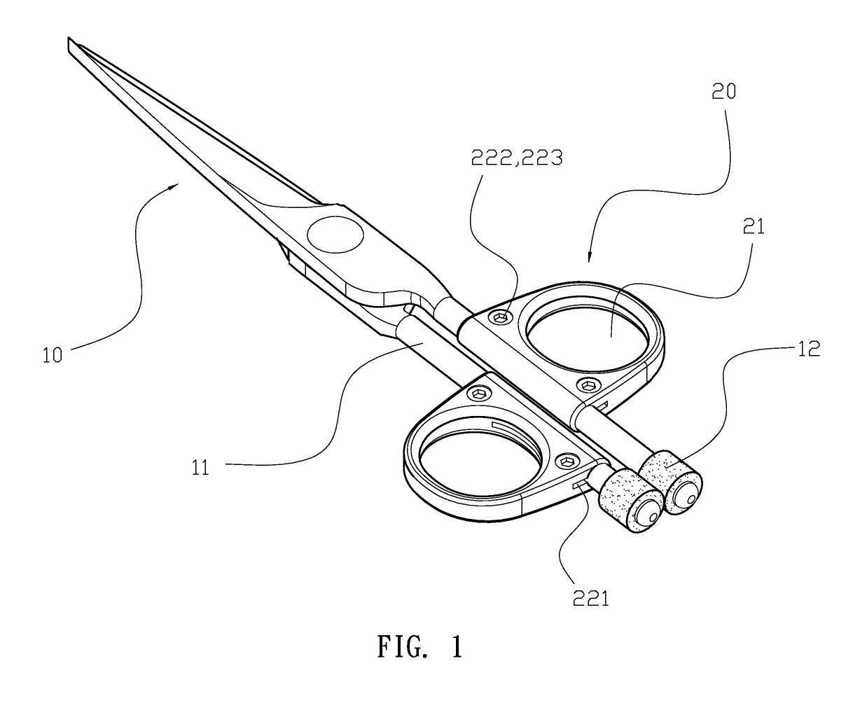

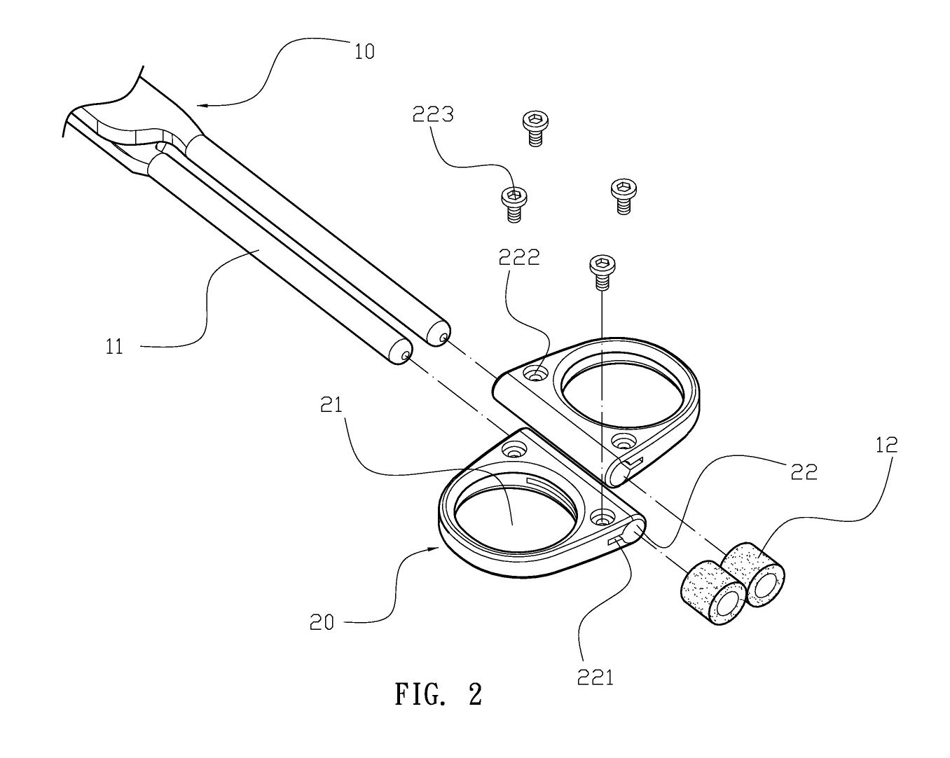

Please refer to FIG. 1 and FIG. 2. An adjustable finger loop structure for a scissors comprises a scissor body 10 and two finger loops 20. The scissors body 10 has two scissor blades pivoted together, and each scissor blade has an extension rod 11. A surface of the extension rod 11 is roughened, such as by sand-blasting. The two finger loops 20 respectively have one circular hole 21 and a through aperture 22 that runs along an inner liner side and is used for jacketing onto a respective extension rod 11. Each through aperture 22 has a radial slot 221, and each radial slot has a plurality of securing apertures 222 passing through the radial slot 221 and corresponding securing members 223 for securing the finger loop 20 onto the respective extension rod 11.

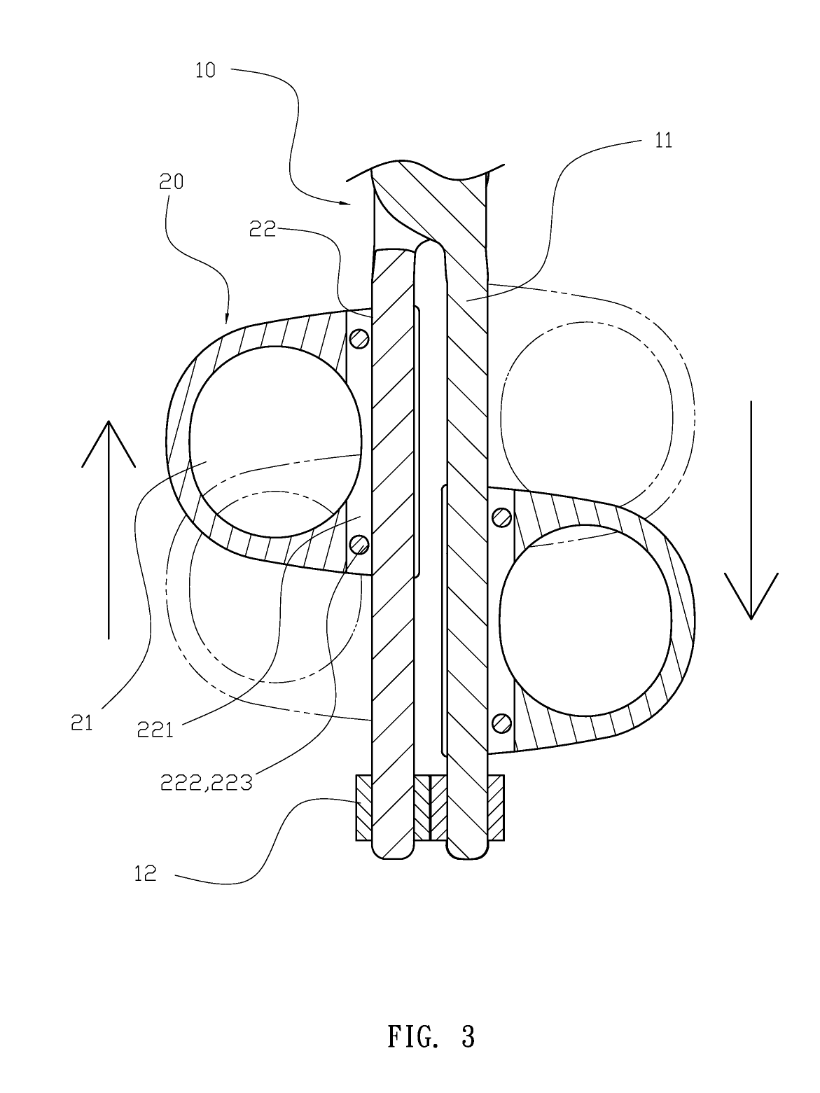

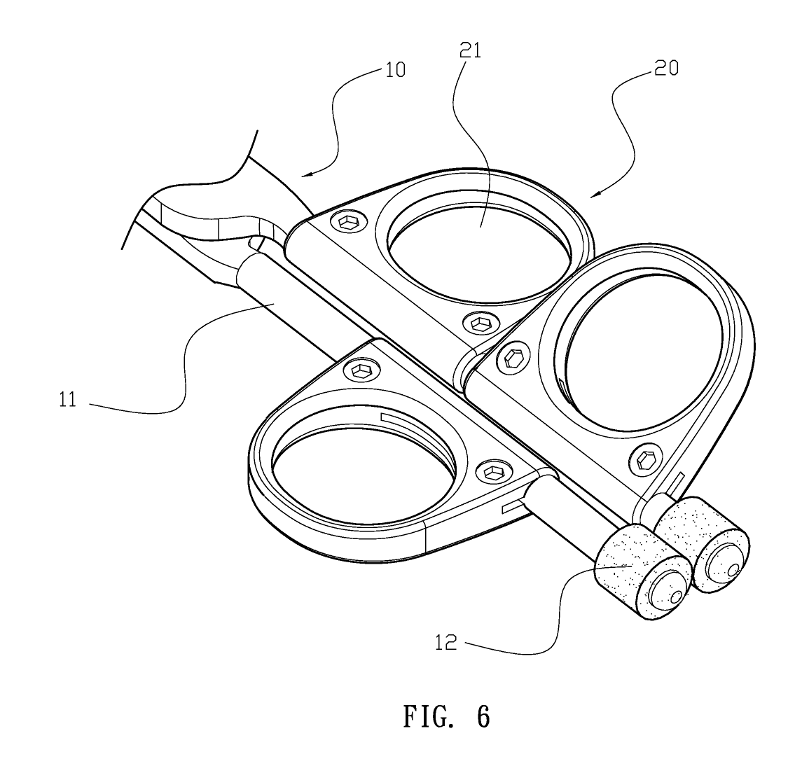

For actual assembly and usage, please refer to FIG. 2 with FIGS. 3˜5. The two finger loops 20 are respectively jacketed on the extension rods 11 of the scissors body 10 via the through apertures 22 and are capable of providing different adjusting positions and angles. Then, the securing members 223 are placed through the respective securing apertures 222 via the radial slot 221 to lock the finger loops 20 tightly onto their respective extension rods 11. Furthermore, more than one finger loop 20 can be installed onto one of the extension rods 11, as shown in FIG. 6. A stopping member 12 may be respectively installed on each extension rod 11 behind a respective finger loop 20 and used for preventing the finger loop 20 from disengaging with the extension rod 10. The stopping member 12 has a radial dimension larger than a distance between an inner edge of the through aperture and the outer edge of the finger loop 20 such that collisions between the two finger loops 20 can be prevented.

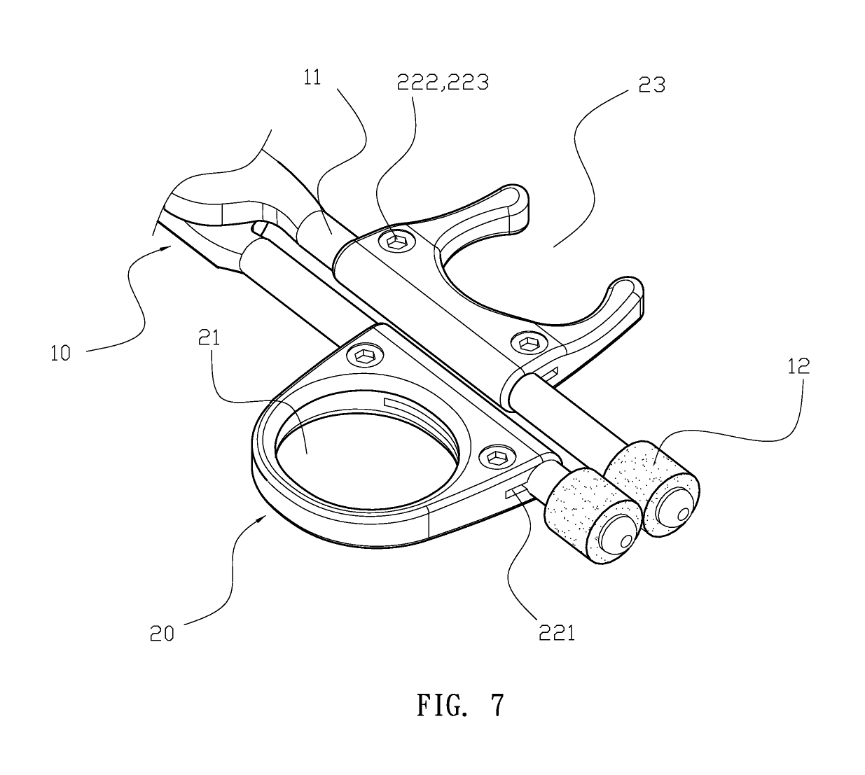

In some embodiments, one opening 23 is formed at an outer edge of a finger loop 20, such that the finger loop 20 is U-shaped, as shown in FIG. 7.

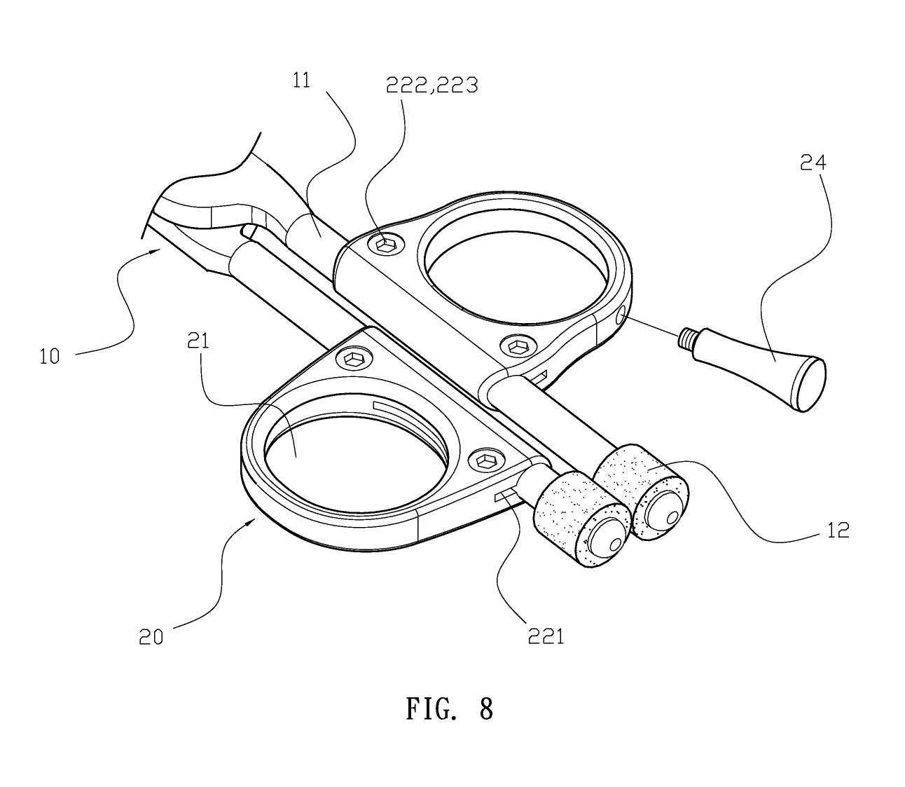

In addition, in some embodiments an assisting rod 24 is installed at a rear end of any one of the finger loops 20 on the extension rod 11 of the scissor body 10 (as shown in FIG. 8), which allows other fingers not passing through the finger loops 20, such as the ring finger or little finger of a user, to rest thereon.

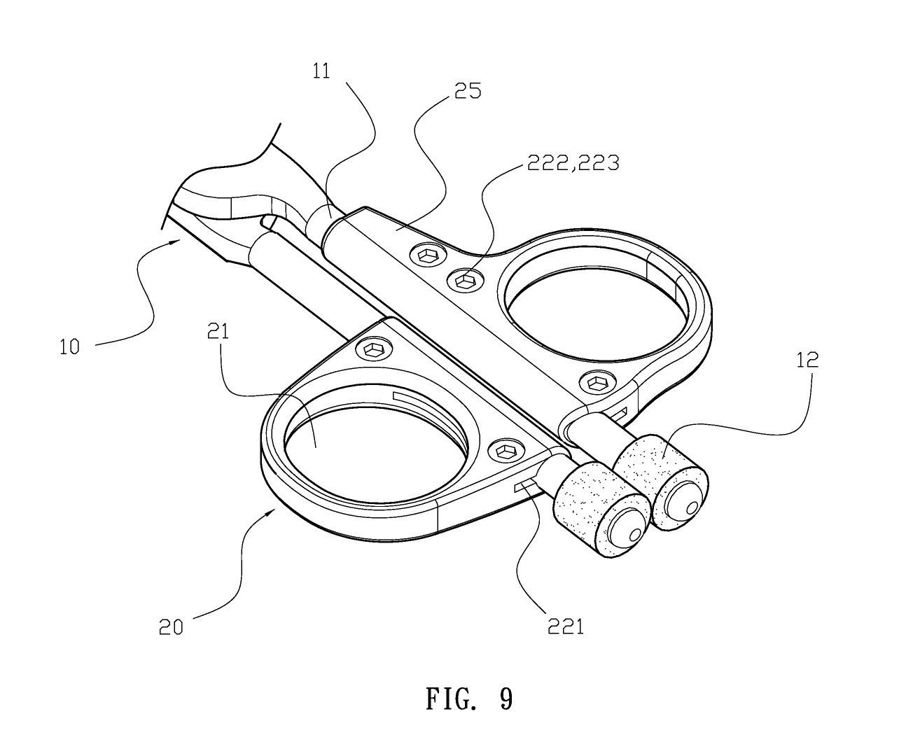

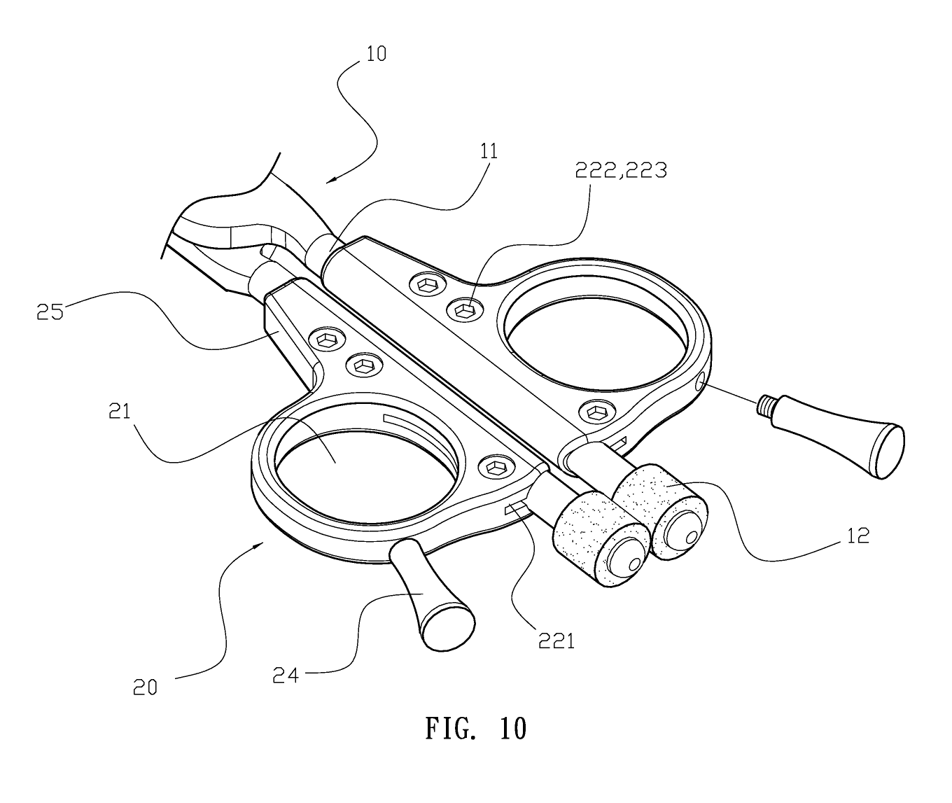

For another embodiment of the adjustable finger loop structure, as shown in FIG. 9, a front end of at least one of the finger loops 20 has an extension for use as a supporting portion 25, or both front ends of the finger loops 20 have an extension for use as supporting portions 25, such that other free fingers of the user can rest thereon, as shown in FIG. 10. Furthermore, the finger loop 20 having the supporting portion 25 may also be installed on the assisting rod 24.

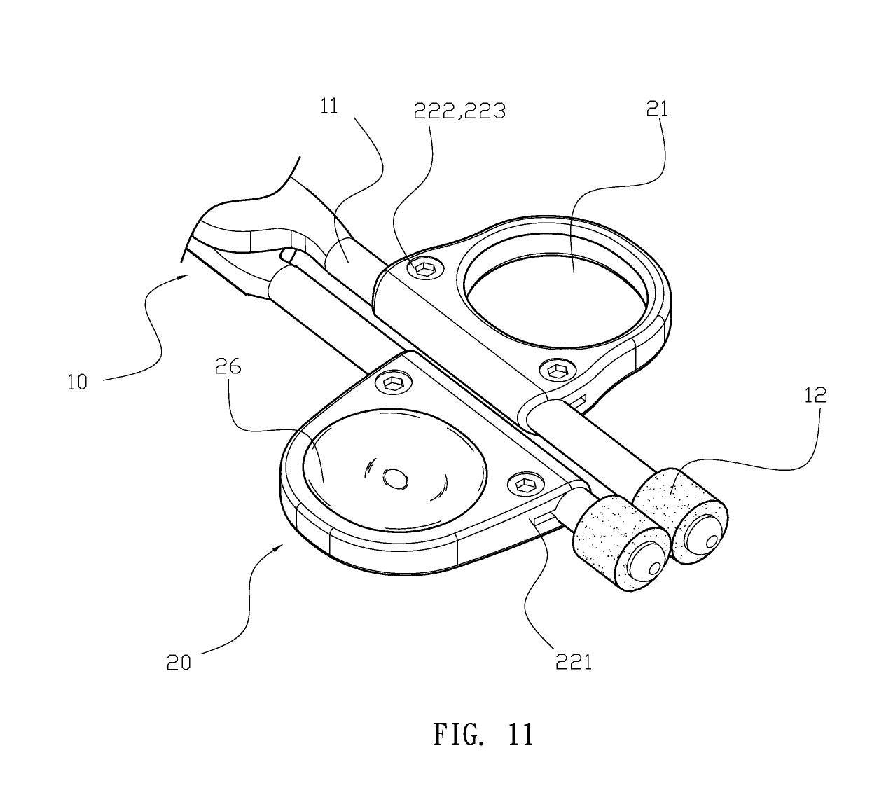

For another embodiment of the adjustable finger loop structure, as shown in FIG. 11, the finger loop 20 does not have a circular hole 21 but instead has an indented surface 26 for the thumb of the user to rest on.

With the above mentioned structure, the following benefits can be obtained: 1. The finger loop 20 provides not only different adjustable positions and angles on the extension rod 11 but also provides different type combinations. 2. The stopping member 12 is respectively installed behind the finger loop 20 on the extension rod 11, which is used for preventing contact between the two finger loops 20.

Although the present invention has been explained in relation to its preferred embodiment, it is to be understood that many other possible modifications and variations can be made without departing from the spirit and scope of the invention as hereinafter claimed.

What is claimed is:

1. An adjustable finger loop structure for a scissors comprising:
a scissors body having two scissor blades pivoted together, each scissor blade having an extension rod;
at least two finger loops, the finger loops each having a through aperture along an inner liner side for jacketing onto a respective extension rod, each through aperture having a radial slot, each radial slot having a plurality of securing apertures passing through the radial slot the and corresponding securing members for securing the finger loop onto the respective extension rod.

2. The adjustable finger loop structure for a scissors as claimed in claim 1, wherein a surface of the extension rods is embossed with patterns.

3. The adjustable finger loop structure for a scissors as claimed in claim 1, wherein a surface of the extension rods is roughened.

4. The adjustable finger loop structure for a scissors as claimed in claim 1, wherein the finger loop has one circular hole.

5. The adjustable finger loop structure for a scissors as claimed in claim 1, wherein the finger loop is U-shaped.

6. The adjustable finger loop structure for a scissors as claimed in claim 1, wherein one of the finger loops has an indented surface.

7. The adjustable finger loop structure for a scissors as claimed in claim 1, wherein a front end of at least one of the finger loops has an extension for use as a supporting portion.

8. The adjustable finger loop structure for a scissors as claimed in claim 4, wherein an assisting rod is installed at a rear end of at least one finger loop to provide a finger pushing surface.

9. The adjustable finger loop structure for a scissors as claimed in claim 6, wherein an assisting rod is installed at a rear end of at least one finger loop to provide a finger pushing surface.

10. The adjustable finger loop structure for a scissors as claimed in claim 7, wherein an assisting rod is installed at a rear end of at least one finger loop to provide a finger pushing surface.

11. The adjustable finger loop structure for a scissors as claimed in claim 1, wherein a stopping member is respectively installed on each extension rod behind the finger loop.

12. The adjustable finger loop structure for a scissors as claimed in claim 11, wherein the stopping member has a radial dimension larger than a distance between an inner edge of through aperture and liner edge of the finger loop.

13. The adjustable finger loop structure for a scissors as claimed in claim 1, wherein each extension rod of the scissors body has a plurality of finger loops.
